(19) United States
(12) Patent Application Publication
(10) Pub. No.: US 2009/0255274 A1
(43) Pub. Date: Oct. 15, 2009

(54) SYSTEM AND METHOD FOR RECHARGING A HIGH PRESSURE GAS STORAGE CONTAINER BY TRANSPORT OF A LOW PRESSURE CRYOGENIC FLUID

(76) Inventors: Eugene K. Ungar, Houston, TX (US); Warren P. Ruemmele, Houston, TX (US); William C. Bohannon, Friendswood, TX (US)

Correspondence Address: NASA JOHNSON SPACE CENTER, MAIL CODE AL, 2101 NASA PARKWAY, HOUSTON, TX, 77058, US

(21) Appl. No.: 12/102,514

(22) Filed: Apr. 14, 2008

(51) Int. Cl. F17C 7/02

(52) U.S. Cl. 62/50.1

(57) ABSTRACT

A method for recharging a high pressure gas storage container unit comprises transporting a recharge gas container containing a fluid at a cryogenic temperature and low pressure; heating the fluid in the recharge gas container and the fluid expelled from the recharge gas container to ambient temperature; and filling the high pressure gas storage container with the heated fluid as a pressurized gas. A system for recharging gas at a high pressure level comprises a recharge gas container unit comprising a means for containing cryogenic liquid and a first means for heating the liquid, the first heating means disposed near an outlet portion of the containing means; a second means for heating operatively connected to the recharge gas container unit during recharge; and a high pressure storage container unit comprising means for storing gas at a high pressure, said storing means operatively connected to the second means for heating during recharge.

### ORIGIN OF THE INVENTION

The invention described herein was made by employee(s) of the United States Government and may be manufactured and used by or for the Government of the United States of America for governmental purposes without the payment of any royalties thereon of therefore. The invention described herein was also made in the performance of work under a NASA contract and is subject to the provisions of Section 305 of the National Aeronautics and Space Act of 1958, Public Law 85-568 (72 Stat. 435, 42 U.S.C. 2457).

### BACKGROUND OF INVENTION

1. Field of the Invention

The invention relates generally to a system and method for recharging a high pressure gas storage container and to an apparatus for transporting a cryogenic fluid at low pressure.

2. Background Art

Gasses are often stored under high pressure in high pressure storage containers, with applications ranging from inert gas storage for welding to oxygen tanks in space. As the pressurized gas is depleted from the high pressure storage container, the pressure of the gas drops. After a period of depletion, the high pressure storage container must be recharged.

Conventionally, the gasses that are used to recharge the depleted storage containers are transported in ambient temperature high pressure recharge gas containers. That is, when recharging a high pressure storage container, a recharge gas container containing the recharge gas at a much higher pressure than the target pressure of the high pressure storage container is transported, connected to the system, and the pressures are allowed to equalize. For example, if pressurized oxygen stored in a storage container at 21 MPa is depleted to 7 MPa, a recharge gas container of equal volume as the high pressure storage container must contain pressurized oxygen at almost 40 MPa in order to fully recharge the storage container to 21 MPa. Thus, the recharge gas container must be designed to withstand significantly higher pressures than the high pressure storage container.

### SUMMARY OF INVENTION

A method for recharging a high pressure gas storage container unit according to one or more embodiments of the present invention comprises the steps of disposing a first heater on a recharge gas container unit, filling a recharge gas container of the recharge gas container unit with fluid in the form of a cryogenic liquid, attaching or otherwise operatively connecting the recharge gas container to a second heater, attaching or otherwise operatively connecting the second heater to the high pressure storage container unit, activating the first heater to cause the cryogenic fluid to expand out of the recharge gas container, and activating the second heater to warm the fluid expelled from the recharge gas container before entry into the high pressure gas storage container unit.

In another embodiment of the invention, a system for recharging gas stored at a high pressure in a storage container according to one or more embodiments of the present invention comprises a recharge gas container unit, a second heater operatively connected to the recharge gas container unit by piping during recharge, and a high pressure storage container unit. The recharge gas container unit comprises a recharge gas container. Fluid in a form of cryogenic fluid is disposed within the recharge gas container. A first heater is operatively connected to the recharge gas container near a neck portion of such container. The high pressure storage container unit comprises a high pressure storage container operatively connected to the second heater by piping during the act of recharging such container.

Other aspects and advantages of the invention will be apparent from the following description and the appended claims.

### BRIEF DESCRIPTION OF DRAWINGS

FIG. 1 shows a cross-sectional view of a recharge gas container unit according to one or more embodiments of the present invention.

FIG. 2 shows a cross-sectional view of a recharge gas container unit connected to a low pressure relief valve unit according to one or more embodiments of the present invention.

FIG. 3 shows a cross-sectional view of a recharge gas container unit connected to a low pressure relief valve unit and a high pressure relief valve unit according to one or more embodiments of the present invention.

FIG. 4 shows a recharge gas container unit, a high pressure relief valve unit, a temperature-controlled heating block unit, and a high pressure storage container unit according to one or more embodiments of the present invention.

FIG. 5 shows a flow chart of the steps for filling and transporting the recharge gas container unit and recharging the high pressure storage container unit according to one or more embodiments of the present invention.

FIG. 6 shows a flow chart of the steps for determining the minimum required heater power ratio between the temperature-controlled block heater and the ring heater according to one or more embodiments of the present invention.

FIG. 7 is a plot of specific volume against specific enthalpy of oxygen for constant pressures ranging from 7 MPa to 21 MPa.

FIG. 8 is a plot of temperature against specific volume of oxygen for constant pressures ranging from 7 MPa to 21 MPa.

FIG. 9 is a plot of temperature against specific enthalpy of oxygen for constant pressures ranging from 7 MPa to 21 MPa.

### DETAILED DESCRIPTION

Exemplary embodiments of the invention will be described with reference to the accompanying figures. Like items in the figures are shown with the same reference numbers.

In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

Embodiments of the invention relate to a system and method for the recharge of gas stored within a high pressure storage container. More specifically, embodiments of the invention relate to an apparatus for transporting recharge gas as a cryogenic liquid and a system and method for recharging a high pressure gas storage container.

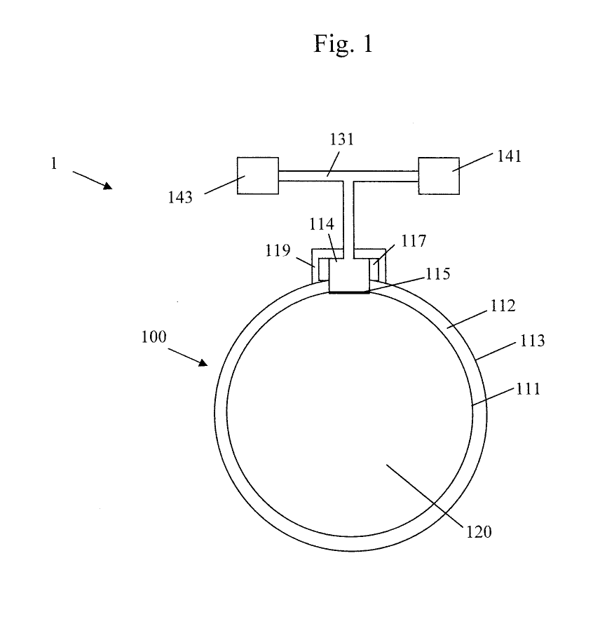

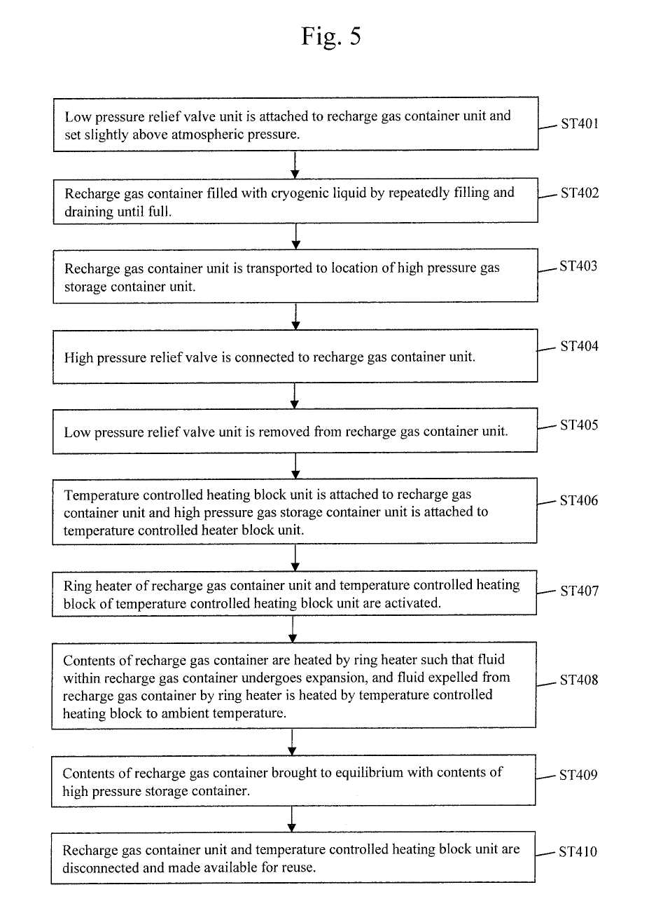

FIGS. 1-4 show a cross-sectional view of a recharge gas container unit 1 during different stages of the gas recharge process according to one or more embodiments of the present invention. FIG. 5 shows a flow chart of the steps of such process for filling and transporting the recharge gas container unit and for recharging or filling the high pressure storage container unit, according to one or more embodiments of the present invention.

Referring now to FIG. 1, a cross-sectional view of a recharge gas container unit 1 is shown according to one or more embodiments of the present invention. The recharge gas container unit 1 has a recharge gas container 100 for containing a fluid, a ring heater 117, ring heater insulation 119, piping 131, and first and second self-sealing quick disconnect fitting halves 141, 143. The recharge gas container 100 in one or more embodiments of the present invention may not actually carry a fluid in the form of gas, i.e., the gas phase.

In one embodiment, the recharge gas container 100 comprises a spherical cryogenic dewar, and has an inner wall 111 and an outer wall 113, with an evacuated space 112 therein filled with insulation. Although in this embodiment the recharge gas container 100 is described as spherical, the recharge gas container may be of other container shapes known in the art, such as a cylinder, tubular, etc. The inner wall 111 may be manufactured of metal or other suitable materials known in the art that can withstand cryogenic temperatures and high pressures. The outer wall 113 may be manufactured of metal or other suitable materials known in the art. At the top of the recharge gas container 100, a container outlet or neck 114, having a single wall layer, is disposed. The recharge gas container 100 is filled with a high void fraction wettable matrix 120, such as fumed silica, to provide fluid management (such as, for example, preventing cryogenic liquid from sloshing) during transport. The wettable matrix 120 is contained within the recharge gas container 100 by a fine screen 115 disposed at the container neck 114. The mesh pattern of the fine screen 115 is fine enough to prevent the wettable matrix 120 from exiting, but coarse enough to let fluid through.

The ring heater 117 is disposed around and operatively connected to the container outlet or neck 114, and the ring heater insulation 119 surrounds the ring heater 117. The ring heater insulation 119 may also surround a portion of the outer wall 113 of the recharge gas container 100, as well as a portion of the piping 131. The ring heater insulation 119 may be a closed cell foam cap, or other insulating materials known in the art. In one embodiment, the piping 131 is in a T-shaped configuration, with one end connected to the container neck 114, and the two other ends each connected to the first and second self-sealing quick disconnect fitting halves 141, 143. In one or more embodiments of the present invention, the piping 131 may be insulated.

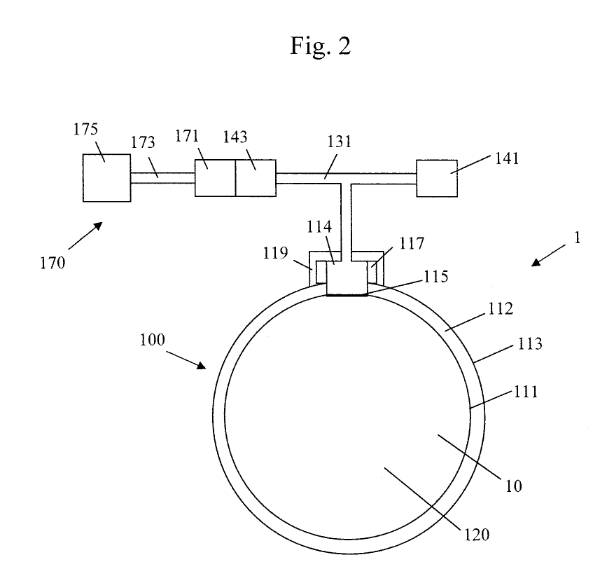

FIG. 2 shows a cross-sectional view of the recharge gas container unit 1 connected to a low pressure relief valve unit 170 according to one or more embodiments of the present invention. Referring now to FIGS. 2 and 5, the low pressure relief valve unit 170, having a low pressure relief valve 175 connected to a self-sealing quick disconnect fitting half 171 via piping 173, is operatively connected to the recharge gas container unit 1 by attaching the self-sealing quick disconnect fitting half 171 of the low pressure relief valve unit 170 to the second self-sealing quick disconnect fitting half 143 of the recharge gas container unit 1. This step of the method is represented as ST401 in FIG. 5. In one or more embodiments of the present invention, the piping 173 may be insulated. The method step (ST 401) further comprises the act of setting the low pressure relief valve 175 slightly above atmospheric pressure. To ready the recharge gas container unit 1 for transport, the recharge gas container 100 is filled with recharge gas that is in one embodiment cooled to a cryogenic liquid 10. The recharge gas container 100 is filled with the cryogenic liquid 10 at or near atmospheric pressure by repeatedly filling and draining the recharge gas container 100 until full (shown as method step ST402). Here, “full” does not necessarily mean that the entirety of the recharge gas container 100 is filled with cryogenic fluid. Instead, “full” means the amount of cryogenic fluid required to recharge or fill the high pressure storage container with gas to a desired pressure. In one or more embodiments of the present invention, when the act of filling the container 100 process is complete, the inner wall 111 of the recharge gas container 100 will be near the temperature of the cryogenic liquid 10.

Once the act of filling of the recharge gas container 100 is completed, it is ready for transport. The low pressure relief valve 175 serves to maintain constant pressure within the recharge gas container 100 when heat leak through the walls of the recharge gas container 100 would otherwise increase the pressure therein. For example, in one embodiment the low pressure relief valve 175 may be set at 0.203 MPa (2 atm). The recharge gas container unit 1 and the low pressure relief valve unit 170 are then transported to the location of the high pressure storage container unit 2, indicated in FIG. 5 as step ST403.

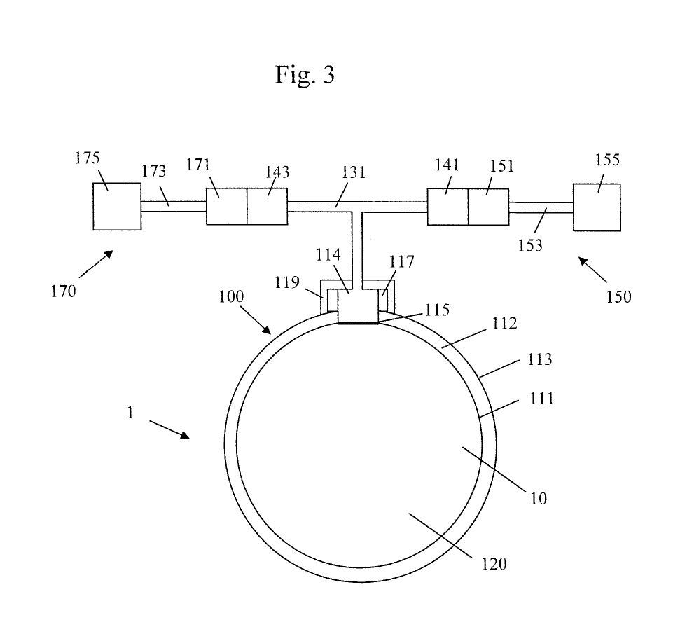

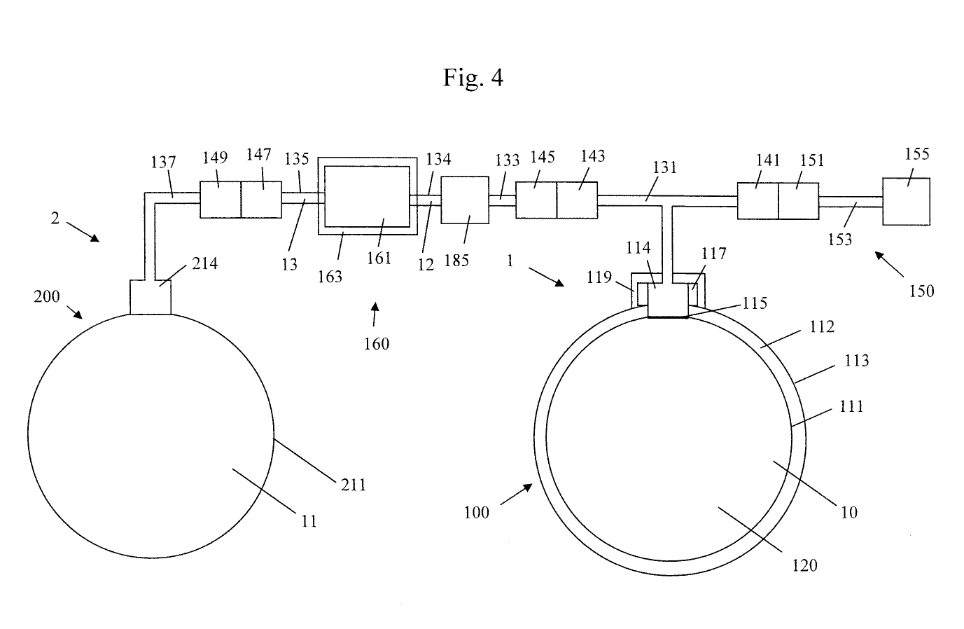

FIG. 3 shows a cross-sectional view of the recharge gas container unit 1 connected to a low pressure relief valve unit 170 and a high pressure relief valve unit 150 according to one or more embodiments of the present invention. Once the recharge gas container 1 and the low pressure relief valve unit 170 have been transported to the location of the high pressure storage container unit 2 (as shown in FIG. 4), the high pressure relief valve unit 150, having a high pressure relief valve 155 connected to a self-sealing quick disconnect fitting half 151 via piping 153, is operatively connected to the recharge gas container unit 1 by attaching the self-sealing quick disconnect fitting half 151 of the high pressure relief valve unit 150 to the first self-sealing quick disconnect fitting half 141 of the recharge gas container unit 1 represented as step ST404 in FIG. 5. In one or more embodiments of the present invention, the piping 153 may be insulated. The high pressure relief valve 155 has a pressure setting corresponding to or consistent with a maximum design pressure of the high pressure storage container unit 2.

FIG. 4 shows a recharge gas container unit 1, a high pressure relief valve unit 150, a temperature-controlled heating block unit 160, and a high pressure storage container unit 2 according to another embodiment of the invention. After the high pressure relief valve unit 150 is operatively connected to the recharge gas container unit 1, the low pressure relief valve unit 170 is removed from the recharge gas container unit 1 (shown as step ST405 in FIG. 5), a temperature-controlled heating block unit 160 is operatively connected to the recharge gas container unit 1, and the temperature-controlled heating block unit 160 is operatively connected to the high pressure storage container unit 2 (shown as step ST406).

In one embodiment, the temperature-controlled heating block unit 160 comprises a temperature-controlled heating block 161, a check valve 185, third and fourth self-sealing quick disconnect fitting halves 145, 147, piping 133 connecting the third self-sealing quick disconnect fitting half 145 to the check valve 185, piping 134 connecting the check valve 185 to the temperature-controlled heating block 161, and piping 135 connecting the temperature-controlled heating block 161 to the fourth self-sealing quick disconnect fitting half 147. The temperature controlled heating block 161 maintains a constant preset temperature when activated. In one or more embodiments of the invention, the preset temperature is ambient. The check valve 185 prevents back flow from the high pressure storage container unit 2. The check valve 185 may have, for example, a ball member and a spring member, such that the ball member blocks fluid flow through the check valve unless the pressure on the inlet side is greater than the pressure on the outlet side of the check valve 185. In one or more embodiments of the present invention, the piping 133, 134, 135 may be insulated. Alternatively, because the fluid exiting the temperature-controlled heating block 161 may be at or near ambient temperature, only the piping 133, 134 on the inlet side of the temperature-controlled heating block 161 may be insulated. Alternatively, only the piping 135 on the outlet side of the temperature-controlled heating block 161 may be insulated. The temperature-controlled heating block 161 is surrounded by insulation 163. The insulation 163 may also cover a portion of the piping 133, 135. The temperature-controlled heating block unit 160 is operatively connected to the recharge gas container unit 1 by attaching the second self-sealing quick disconnect fitting half 143 of the recharge gas container unit 1 to the third self-sealing quick disconnect fitting half 145 of the temperature-controlled heating block unit 160 (shown as a portion of method step ST406).

The high pressure storage container unit 2 includes a high pressure storage container 200, a fifth self-sealing quick disconnect fitting half 149, and piping 137 connecting the fifth self-sealing quick disconnect fitting half 149 to the high pressure storage container 200. The high pressure storage container includes a container wall 211 and a container inlet or neck 214 which is attached to the piping 137. In one or more embodiments of the present invention, the piping 137 is insulated. The high pressure storage container 200 is capable of containing pressurized gas 11 at a high pressure level. The temperature-controlled heating block unit 160 is attached to the high pressure storage container unit 2 by attaching the fifth self-sealing quick disconnect fitting half 149 of the high pressure storage container unit 2 to the fourth self-sealing quick disconnect fitting half 147 of the temperature-controlled heating block unit 160 (shown as a portion of method step ST406 of FIG. 5).

Once the recharge gas container unit 1, the temperature-controlled heating block unit 160, and the high pressure storage container unit 2 are operatively connected or attached as shown in FIG. 4, the pressurized gas 11 in the high pressure storage container 200 typically expands into the temperature-controlled heating block unit 160, raising the pressure in the entire unit excepting the piping 133 and self-sealing quick disconnect fitting half 145.

As shown in FIG. 5, the next step of the process for recharging the high pressure storage container unit comprises step ST407. For this step, the ring heater 117 of the recharge gas container unit 1 and the temperature-controlled heating block 161 of temperature-controlled heating block unit 160 are activated. The ring heater 117 heats the contents of the recharge gas container 100 such that the contents undergo pressurization and expansion. Once pressure within the recharge gas container unit 1 has equalized with the pressure within the high pressure storage container unit 2, the expanding fluid 12 (previously fluid 10) flows into the temperature-controlled heater block 161 by way of the piping 131, 133 (shown as a portion of step ST408). The process or method of recharging continues when the temperature-controlled heater block 161 heats the expanding fluid 12 to ambient temperature (also shown as method step ST408), resulting in a supercritical fluid 13 at point of entry into the high pressure storage container.

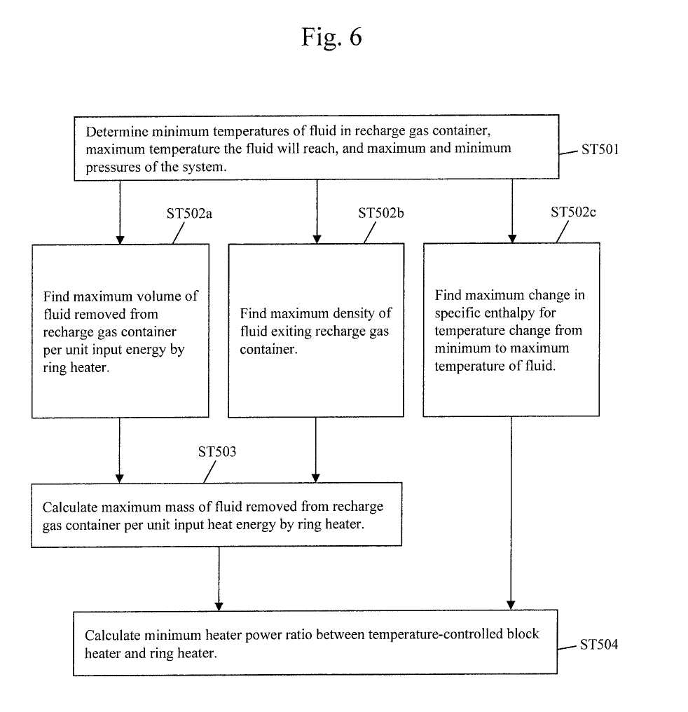

To ensure that all fluid entering the high pressure storage container 200 is at ambient temperature, a proper heating ratio is necessary between the heater power of the temperature-controlled block heater 161 and the ring heater 117. The method for calculating this ratio will be explained in more detail below with reference to FIGS. 6-9. Because only ambient temperature gas enters the high pressure storage container 200, the embodiments disclosed herein need not make the high pressure storage container 200 or its valving compatible with cryogenic temperatures and fluids.

Now at ambient temperature, the fluid 13 flows into the high pressure storage container 200 by way of piping 135, 137. Delivery of the fluid to the high pressure storage container 200 is regulated partially by controlling the ring heater 117 and can be reduced to a minimum flow by turning the ring heater off. The act of transfer is done after the heaters have brought all or substantially all of the contents (fluid 10) of the recharge gas container 100 to ambient temperature and the contents of the high pressure storage container 200 have reached thermal equilibrium with its surroundings (shown as step ST409 in FIG. 5).

At this point, the pressurized fluid 13 originating from the recharge gas container 100 and the gas 11 of the high pressure storage container 200 are at equilibrium. That is, the pressurized fluid inside the recharge gas container 100 and the high pressure storage container 200 are at ambient temperature and at the desired gas pressure of the high pressure storage container 200. Having the benefit of this description, one of ordinary skill in the art will now recognize that this equilibrium pressure can be controlled by the amount of cryogenic fluid 10 that was transferred to the recharge gas container 100 (at step ST402).

Once the pressures in the recharge gas container 100 and the high pressure storage container 200 have equalized, the fluid transfer is finished and recharge has been accomplished. The recharge gas container unit 100 is then operatively disconnected at the self-sealing quick disconnect fitting half 143 and is available for reuse. Similarly, the temperature-controlled heating block unit 160 is operatively disconnected at the self-sealing quick disconnect fitting half 147 and stored for future use, as shown by method ST410 of FIG. 5.

The method for sizing the heating system with a heating ratio that will work will now be explained with reference to FIGS. 6-9. In order to facilitate the explanation, an example of transporting oxygen at 0.203 MPa (2 atm) to recharge an ambient temperature (i.e., 21° C.) pressurized oxygen container from 7 MPa to 21 MPa is detailed below. In the example, the cryogenic liquid oxygen starts at −176° C. Although the method is presented using the example of recharging a high pressure storage container containing oxygen at 7 MPa to 21 MPa, the methodology itself is generic, and one of ordinary skill in the art, after having the benefit of this description, will recognize that the system and method can be applied to virtually any other gas and any other pressurized gas container pressure range.

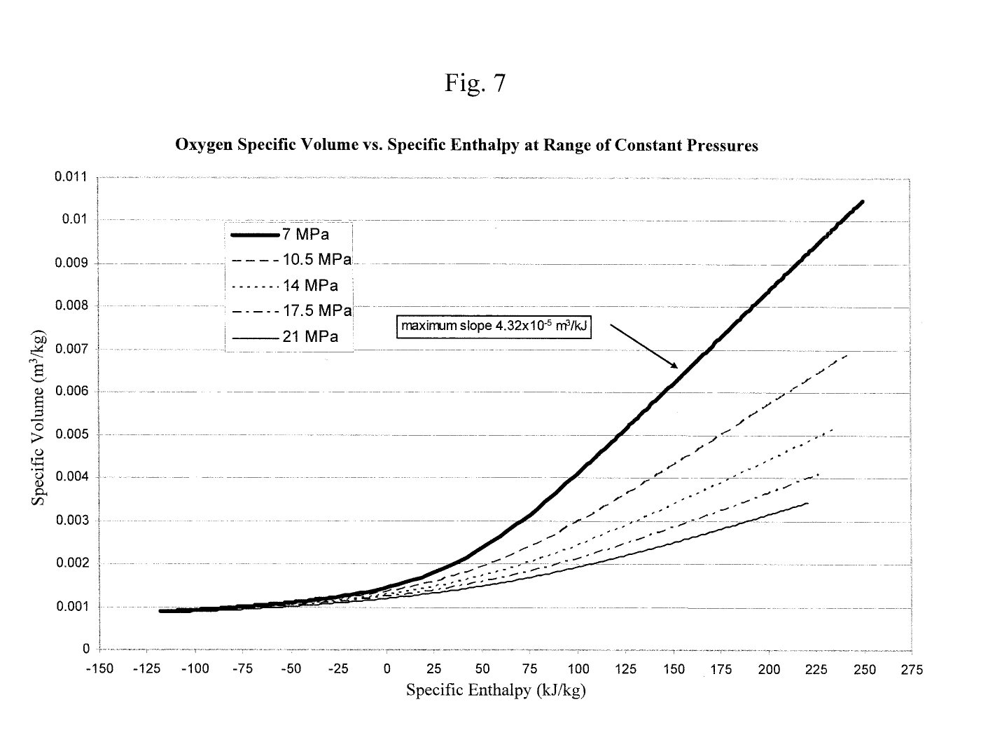

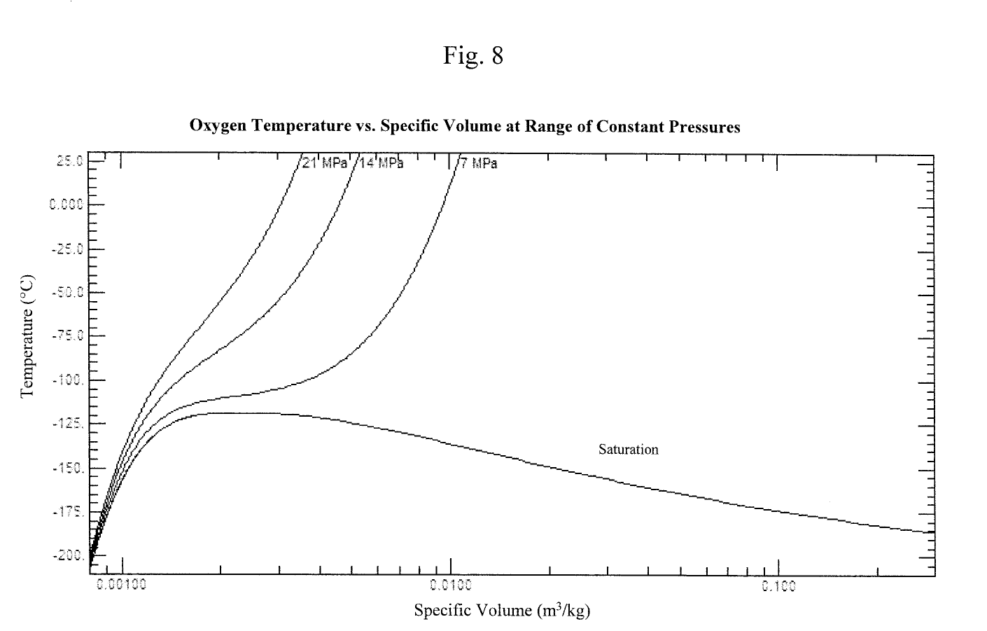

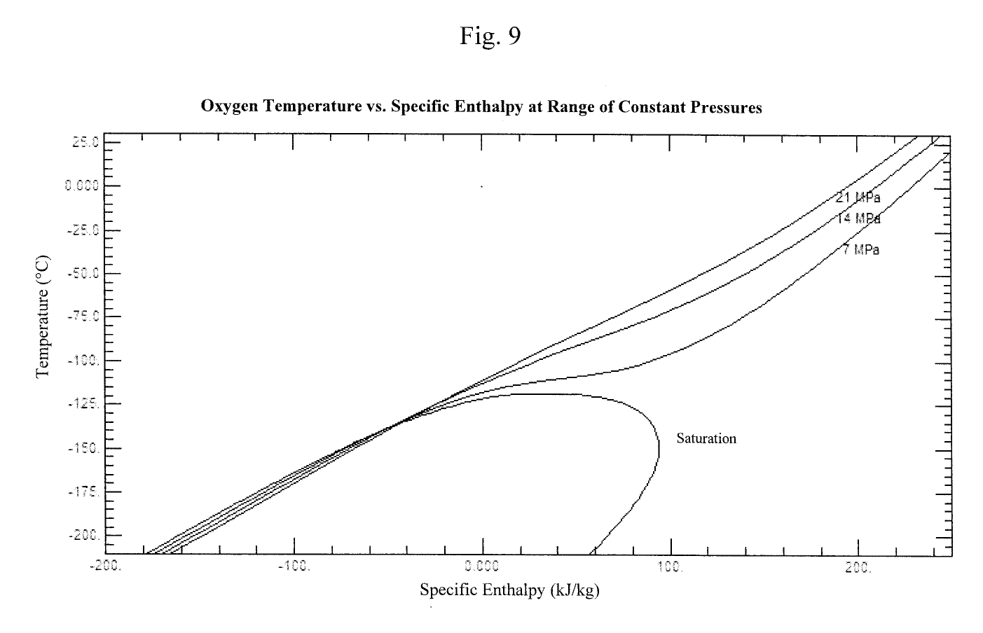

FIG. 6 shows a flow chart of the steps for the process for determining the minimum size ratio between the temperature-controlled block heater 161 and the ring heater 117 according to one or more embodiments. FIG. 7 is a plot of specific volume against specific enthalpy of oxygen for constant pressures ranging from 7 MPa to 21 MPa. FIG. 8 is a plot of temperature against specific volume of oxygen for constant pressures ranging from 7 MPa to 21 MPa and at saturation. FIG. 9 is a plot of temperature against specific enthalpy of oxygen for constant pressures ranging from 7 MPa to 21 MPa and at saturation.

As explained above, to ensure that all fluid entering the high pressure storage container 200 is at ambient temperature, a proper ratio is necessary between the heater powers of the temperature-controlled block heater 161 and the ring heater 117. That is, the temperature-controlled block heater 161 must have sufficient heating power to heat the fluid 10 exiting from the recharge gas container 100 up to ambient temperature under a “highest demand” scenario. The “highest demand” scenario in this case would occur when the fluid being expelled from the recharge gas container 100 is at maximum volume per input energy and at maximum density, thereby requiring the maximum energy for the temperature-controlled block heater 161 to heat a mass of supercritical fluid (i.e. change its specific enthalpy) from the minimum temperature of the cryogenic liquid (“Tₘᵢₙ”) to the maximum temperature that the fluid will reach (“Tₘₐₓ”).

Accordingly, the method first comprises the step ST501 of determining Tₘᵢₙ, Tₘₐₓ, maximum pressure (“Pₘₐₓ”), and minimum pressure (“Pₘᵢₙ”) of the system. In the present example involving oxygen, Tₘᵢₙ is −176° C., Tₘₐₓ is an ambient temperature of 21° C., and the Pₘᵢₙ and Pₘₐₓ are 7 MPa and 21 MPa, respectively.

Given that the specific volume is plotted against specific enthalpy for a range of constant pressures from Pₘᵢₙ to Pₘₐₓ over the temperature range from Tₘᵢₙ to Tₘₐₓ, the maximum slope is determined from the plot. In other words, the maximum volume of fluid expelled from the recharge gas container per unit heat input (“ΔVₘₐₓ/ΔE”) by the ring heater is determined at step ST502a. FIG. 7 shows the specific volume-specific enthalpy plot of oxygen for constant pressures ranging from 7 MPa to 21 MPa over a temperature range from −176° C. to 21° C. The maximum slope in the plot of FIG. 7 is 4.32*10⁻⁵ m³/kJ. That is, for each kJ of heat energy input, a maximum of 4.32*10⁻⁵ m³ of oxygen is expelled from the recharge gas container 100 and enters the temperature-controlled block heater 161.

Temperature is plotted against specific volume for a range of constant pressure from Pₘᵢₙ in to Pₘₐₓ, and the minimum specific volume (“υₘᵢₙ”) at Tₘᵢₙ is determined from the plot. The inverse of υₘᵢₙ, which is equal to the maximum density (“ρₘₐₓ”) of the fluid, is then calculated at step ST502b. FIG. 8 shows the temperature-specific volume plot of oxygen for constant pressures ranging from 7 MPa to 21 MPa. In the example plot, υₘᵢₙ is 8.68*10⁻⁴ m³/kg, at 21 MPa and −176° C. Thus, ρₘₐₓ is the inverse of υₘᵢₙ, which is 1.15*10³ kg/m³.

Temperature is plotted against specific enthalpy for a range of constant pressure from Pₘᵢₙ to Pₘₐₓ, and the maximum change in specific enthalpy (“Δhₘₐₓ”) when the temperature is raised from Tₘᵢₙ to Tₘₐₓ is determined from the plot at step ST502c. That is, the maximum amount of input heat energy necessary to heat a unit mass from Tₘᵢₙ to Tₘₐₓ is determined. FIG. 9 shows the temperature-specific enthalpy plot of oxygen for constant pressures ranging from 7 MPa to 21 MPa. In the example plot, Δhₘₐₓ, which occurs at 7 MPa, is 369 kJ/kg.

Once ΔVₘₐₓ/ΔE and ρₘₐₓ are calculated, their product will yield the maximum mass of fluid expelled from the recharge gas container 100 per unit input heat energy (“ΔMₘₐₓ/ΔE”) supplied by the ring heater 117 as shown by step ST503. In the present example, the product of ΔVₘₐₓ/ΔE and ρₘₐₓ yields 4.97*10⁻² kg/kJ. Thus, in the example, a maximum of 4.97*10⁻² kg of supercritical oxygen is expelled from the recharge gas container 100 per 1 kJ of heat energy inputted by the ring heater 117.
Next, once ΔMₘₐₓ/ΔE and Δhₘₐₓ are calculated, their product will yield the necessary minimum size ratio (“rₘᵢₙ”) between the temperature-controlled block heater 161 and the ring heater 117 to ensure that all fluid exiting the temperature-controlled block heater 161 and entering the high pressure storage container 200 is at an ambient temperature. In the present example, rₘᵢₙ is calculated to be 18.3. Thus, in the example, the temperature-controlled block heater 161 must be sized to heat at least 18.3 times as much as the ring heater 117 to ensure that only ambient temperature gas will enter the high pressure storage container 200.

One or more embodiments of the present invention have one or more of the following advantages. The high pressure storage container 200 can be recharged without transporting gasses at high pressure in the recharge gas container 100. The transport of the recharge gas container is safer because the fluid can be transported near atmospheric pressure. The high pressure storage container 200 does not have to be designed to withstand cryogenic temperatures. The recharge gas container 100 does not have to be designed to withstand pressures higher than a target pressure of the high pressure storage container 200. A conventional high pressure storage container 200 can be recharged by the process.

Although only a few exemplary embodiments of this invention have been described in detail above, those skilled in the art, having benefit of this description, will readily appreciate that many modifications are possible in the exemplary embodiments without materially departing from the novel teachings and advantages of this invention. Accordingly, all such modifications are intended to be included within the scope of this invention as defined in the following claims. In the claims, means-plus-function and step-plus-function clauses are intended to cover the structures or acts described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. A method for recharging gas at a high pressure level comprising the steps of:
disposing a first heater on a recharge gas container unit;
filling a recharge gas container of the recharge gas container unit with fluid in the form of a cryogenic liquid at a pressure level below the high pressure level of the gas to be recharged;
operatively connecting the recharge gas container to a second heater;
operatively connecting the second heater to a high pressure storage container unit; and
activating the first heater to cause the fluid to expand and exit out of the recharge gas container and the second heater to warm the fluid that has exited from the recharge gas container.

2. The method of claim 1, further comprising:
transporting the recharge gas container unit to the high pressure storage container unit with a low pressure relief valve attached to the recharge gas container unit after the step of filling is performed.

3. The method of claim 2, wherein the low pressure relief valve is set slightly above atmospheric pressure.

4. The method of claim 2, further comprising the step of removing the low pressure relief valve and attaching a high pressure relief valve to the recharge gas container before the step of operatively connecting the recharge gas container to the second heater.

5. The method of claim 1, further comprising the step of operatively connecting a check valve between the recharge gas container unit and the second heater.

6. The method of claim 1, wherein the fluid that has exited the recharge gas container is warmed by the second heater to ambient temperature.

7. The method of claim 1, wherein the step of activating the first heater and the second heater is continued until the fluid contained in the recharge gas container and in a high pressure storage container of the high pressure storage container unit are brought to equilibrium.

8. The method of claim 2, wherein the step of transporting the recharge gas container unit further comprises providing a high void fraction wettable matrix to provide fluid management during the step of transporting.

9. The method of claim 8, wherein the step of transporting the recharge gas container unit further comprises providing a fine screen disposed on a neck portion of the recharge gas container to keep the wettable matrix within the recharge gas container.

10. The method of claim 1, wherein the second heater is a temperature-controlled block heater.

11. The method of claim 6, wherein the step of activating the first heater and the second heater is performed such that a heating power of the second heater is greater than a heating power of the first heater.

12. The method of claim 11, wherein the step of activating the first heater and the second heater is performed such that a heater power ratio between the second heater and the first heater is at least a value determined by multiplying a maximum mass of fluid expelled from the recharge gas container per unit input heat energy from the first heater and a maximum change in specific enthalpy during recharging of the high pressure storage container unit.

13. The method of claim 11, wherein the step of activating the first heater and the second heater is performed such that a heater power ratio between the second heater and the first heater is at least a value determined by:
determining a minimum temperature, a maximum temperature, a minimum pressure, and a maximum pressure of the fluid during recharging of the high pressure storage container unit;
finding a maximum volume of fluid expelled from the recharge gas container per unit input energy from the first heater;
finding a maximum density of fluid exiting the recharge gas container;
finding a maximum change in specific enthalpy for temperature change from the minimum temperature to the maximum temperature of fluid entering the second heater;
calculating a maximum mass of fluid expelled from the recharge gas container per unit input energy from first heater by multiplying the maximum volume of fluid expelled from the recharge gas container per unit input energy from the first heater and the maximum density of fluid exiting the recharge gas container; and
calculating the minimum value of such heater power ratio by multiplying the maximum change in specific enthalpy for temperature change from the minimum temperature to the maximum temperature of fluid entering the second heater and the maximum mass of fluid expelled from the recharge gas container per unit input energy from the first heater.

14. The method of claim 1, wherein the first heater and the second heater are activated simultaneously.

15. A system for recharging gas at a high pressure level, comprising:
a recharge gas container unit comprising:
means for containing a recharge fluid in a form of cryogenic liquid; and
a first means for heating the recharge fluid, the first means for heating disposed near an outlet portion of the containing means;
a second means for heating operatively connected to the recharge gas container unit during recharge; and
a high pressure storage container unit comprising:
means for storing gas at a high pressure, said storing means operatively connected to the second means for heating during recharge.

16. The system of claim 15, wherein the containing means is a cryogenic dewar comprising an outer wall, an inner wall, and a vacuum disposed between the outer wall and the inner wall.

17. The system of claim 15, wherein a high void fraction wettable matrix is disposed within the containing means, and a fine screen is disposed at an outlet portion of the containing means, the fine screen being fine enough to contain the wettable matrix, but coarse enough to let fluid through.

18. The system of claim 15, wherein the first means for heating is a ring heater disposed around a neck portion of the containing means.

19. The system of claim 15, wherein a ratio of the heating power of the second means for heating to the heating power of the first means for heating is of large enough value that fluid exiting the second means for heating and entering into the means for storing gas at high pressure is near ambient temperature.

20. The system of claim 15, wherein a ratio of the heating power of the second means for heating to the heating power of the first means for heating is larger than a ratio calculated by multiplying a maximum mass of fluid expelled from the containing means per unit input heat energy from the first means for heating and a maximum change in specific enthalpy during recharging of the high pressure storage container unit.

21. A method for recharging a high pressure gas storage container, the method comprising:
transporting a recharge gas container containing a fluid at a cryogenic temperature and low pressure;
heating the fluid in the recharge gas container and the fluid expelled from the recharge gas container to ambient temperature; and
filling the high pressure gas storage container with the heated fluid as a pressurized gas.
